(19) United States
(12) Patent Application Publication
(10) Pub. No.: US 2006/0235118 A1
(43) Pub. Date: Oct. 19, 2006

(54) Antiblock additives for monovinylarene-conjugated diene block copolymers

(76) Inventors: Larry M. Selby, Bartlesville, OK (US); Larry L. Nash, Bartlesville, OK (US); Amelia R. Nash, Bartlesville, OK (US); Nathan E. Stacy, Tulsa, OK (US); Steven Bridges, Bartlesville, OK (US)

Correspondence Address: WILLIAMS, MORGAN & AMERSON, 10333 RICHMOND, SUITE 1100, HOUSTON, TX, 77042, US

(21) Appl. No.: 11/108,611

(22) Filed: Apr. 18, 2005

(51) Int. Cl. B32B 7/12

(52) U.S. Cl. 524/186

(57) ABSTRACT

Monovinylarene-conjugated diene copolymer compositions that comprise at least one erucamide and at least one stearamide or behenamide exhibit reduced blocking.

### BACKGROUND OF THE INVENTION

The present invention relates generally to compositions comprising monovinylarene-conjugated diene copolymers.

“Blocking” refers to unwanted adhesion between polymer particles or articles. This is a sometimes a problem with monovinylarene-conjugated diene copolymers. One type of blocking is the tendency of resin pellets to agglomerate. The agglomeration can cause difficulties in storing and conveying polymer pellets. For example, if a storage silo or railcar becomes blocked by pellets, cleaning is often difficult, expensive, and time consuming. If a storage silo becomes blocked, it is sometimes necessary for the plant producing the pellets to sit idle while the silo is cleaned.

Blocking can also cause problems in using the polymer in certain applications, such as medical tubing, in which two polymeric surfaces (e.g., opposing sides on the inner diameter of the tubing) are sometimes pressed into contact and then must be able to release from each other. A polymer that exhibits blocking problems may not be suitable for use in medical tubing.

Another example is film blocking, in which the wound layers of a roll of film, either a consumer product or a large “mill roll” of film, can begin to stick together. The result is that the film becomes difficult, and in some cases impossible, to unroll and use.

There is a need for polymer compositions that exhibit relatively low blocking force.

### SUMMARY OF THE INVENTION

One aspect of the invention is a composition comprising (a) at least one monovinylarene-conjugated diene copolymer, (b) at least one erucamide, and (c) at least one stearamide or behenamide. In certain embodiments, the composition can comprise from about 0.1 wt % to about 5 wt % erucamide and from about 0.1 wt % to about 5 wt % stearamide, behenamide, or a combination of the two. In other embodiments, the erucamide and the stearamide and/or behenamide can each be present in the composition in an amount from about 0.2 wt % to about 2 wt %, and in certain embodiments, from about 0.5 wt % to about 1.5 wt %.

Another aspect of the invention is a method of preparing a polymer composition, comprising combining at least one monovinylarene-conjugated diene copolymer with at least one erucamide and at least one stearamide or behenamide.

Another aspect of the invention is an article that comprises the above-described composition. The article can take a variety of forms, including but not limited to medical grade tubing, packaging articles, window pieces, or toys.

### DESCRIPTION OF ILLUSTRATIVE EMBODIMENTS

A composition of the present invention comprises (a) at least one monovinylarene-conjugated diene copolymer, (b) at least one erucamide, and (c) at least one stearamide or behenamide. It should be understood that the composition could comprise more than one such copolymer, as well as more than one erucamide, stearamide, and/or behenamide. It should also be understood that the composition could comprise both at least one stearamide and at least one behenamide, rather than only containing one or the other.

A variety of monovinylarene-conjugated diene copolymers can be used in the composition. For example, the monovinylarene-conjugated diene copolymer can comprise at least one monovinylarene-conjugated diene tapered block. In certain embodiments, the copolymer can comprise at least two or three consecutive monovinylarene-conjugated diene tapered blocks. “Tapered block” as used herein refers to a polymer block comprising a mixture of monovinylarene and conjugated diene monomers. As used herein, “consecutive” means at least two sequential tapered blocks with no intervening homopolymer blocks.

Suitable copolymers can be produced from polymerization of at least one conjugated diene monomer and at least one monovinylarene monomer. Suitable conjugated dienes which can be used in the polymerization reactions include those having 4 to 12 carbon atoms per molecule, or, in certain embodiments, 4 to 8 carbon atoms. Examples of suitable conjugated diene compounds include 1,3-butadiene, 2-methyl-1,3-butadiene, 2-ethyl-1,3-butadiene, 2,3-dimethyl-1,3-butadiene, 1,3-pentadiene, 3-butyl-1,3-octadiene, isoprene, and mixtures thereof. Suitable monovinylarene compounds which can be used in the polymerization reactions include those having 8 to 18 carbon atoms per molecule, or, in some embodiments, 8 to 12 carbon atoms. Examples of suitable monovinylarene compounds include styrene, alpha-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene, and mixtures thereof.

In some embodiments, the copolymer can be a styrene-butadiene copolymer. Such materials are commercially available, for example as K-Resin® styrene-butadiene copolymers from Chevron Phillips Chemical Company LP.

The relative amount of conjugated diene and monovinylarene in the copolymer can vary depending on the particular characteristics desired. In some embodiments, the monovinylarene content of the copolymer will be from about 60 wt % to about 90 wt %. In other embodiments, the monovinylarene content can be from about 64 wt % to about 76 wt %. In further possible embodiments, suitable monovinylarene-conjugated diene copolymers could also include bimodal tapered copolymers with at least 30 wt % blocky styrene content.

Suitable monovinylarene-conjugated diene copolymers and methods for their production are well-known in the art. Examples of suitable copolymers and methods for their production are disclosed in U.S. Pat. Nos. 4,091,053; 4,704,435; 5,545,690; 5,910,546; 6,096,828; 6,265,484; 6,265,485; 6,420,486; and 6,444,755, which are incorporated herein by reference.

In addition to at least one monovinylarene-conjugated diene copolymer, the composition comprises at least one erucamide and either at least one stearamide or at least one behenamide (or both at least one stearamide and at least one behenamide). In one embodiment, the erucamide and the stearamide and/or behenamide are present in a concentration sufficient such that the composition has a compression force to fail of less than about 40 pounds. An example of a suitable erucamide is Chemstat HTSA #22, which is available from Ruetgers Performance Chemicals. An example of a suitable stearamide is Crodamide SR, which is available from Croda Universal Inc. An example of a suitable behenamide is Kemamide B, which is available from Crompton Corporation.

The composition can optionally also contain additives such as stabilizers, anti-oxidants, mold release agents, dyes, pigments, wax, mineral oil, and flame retardants, as well as fillers and reinforcing agents, such as glass fibers.

The composition optionally can be blended with one or more compatible polymers. Suitable examples of compatible polymers include, but are not limited to polystyrene, styrene butadiene rubber (SBR), styrene butylacrylate block copolymer (SBA), styrene methyl methacrylate block copolymer (SMMA), and styrene butylacrylate methyl methacrylate block copolymer (SBA/MMA). Another aspect of the invention is a method of preparing a polymer composition, comprising combining at least one monovinylarene-conjugated diene copolymer with at least one erucamide and at least one stearamide or behenamide. In an embodiment the combining of at least one monovinylarene-conjugated diene copolymer with at least one erucamide and at least one stearamide or behenamide can occur by any effective method. In an embodiment, this combining may occur by dry blending followed by pelletizing. In another embodiment, this combining may occur by an external dusting of the pellets with the erucamide and at least one stearamide or behenamide. In an embodiment, this combining may occur by adding the erucamide and at least one stearamide or behenamide directly to the molten polymer followed by melt blending. In an embodiment, this combining may occur by mixing a solution of the erucamide and at least one stearamide or behenamide with a solution of the polymer. In any of these methods of combining, oil may be used to aid in the distribution of the erucamide and at least one stearamide or behenamide.

The composition can be used to form various articles. For example, the composition can be used to make film, toys, window pieces, packaging articles, beverage containers, or medical parts or devices. As one specific example, the low blocking properties of the composition make it well-suited for use in medical tubing, wherein the tubing will at times be clamped shut, and after the clamp is removed, the tubing surfaces that have been clamped in contact with each other must release and allow the tubing to return to approximately its original tubular configuration. The composition can be formed into such articles by one or more well-known methods, such as milling, extrusion, blow molding, or injection molding.

The following examples are included to demonstrate embodiments of the invention. It should be appreciated by those of skill in the art that the techniques disclosed in the examples which follow represent techniques discovered by the inventor to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the spirit and scope of the invention.

### Example 1

Blocking force was measured using the following procedure. A 6 inch long by 3 inch inner diameter PVC pipe was lightly sprayed with silicone spray and the excess was gently removed by softly wiping the inside of the cylinder with a shop towel. 300 grams of polymer pellets were weighed into the coated PVC container. The containers were placed in a container separator/holder and then placed inside a stainless steel pan. To ensure that the pellets did not stick to the weight, a piece of polyethylene film was laid on top of the pellets. A 1.25 kg or a 2.5 kg weight was chosen, and placed on top of the film. The 1.25 kg weight was used to simulate conditions in a box that holds 1,000 lb of polymer, and the 2.5 kg weight was used to simulate conditions in a rail car. The containers were then placed into a forced air oven at 150° F. for 90 hours. After 90 hours, the samples were removed and allowed to cool to room temperature before removing the cylinder from the PVC shell. The samples were gently removed, bagged and transferred to the testing lab where they were measured in an Instron tester for the force required to begin breaking the samples apart. This force is the compression force to fail and is one measure of the blocking force. This force is listed under the heading “lbs of Force to Fail” in the subsequent tables. Some of the samples crumbled, meaning that the sample did not reach the point of further testing without breaking into smaller pieces; this was due to the polymer sticking inside the container. In those instances, when the sample was removed from the container, it was felt that it was too damaged to be a representative sample for the Instron blocking test but was still considered to be passing since it crumbled upon removal from the testing container.

Tables 1 and 2 summarize the compression force to fail for various commercial grade styrene-butadiene copolymers, measured using the 2.5 kg weight.

TABLE 1
Commercial Resin Compression Force to Fail Values

| | | lbs of | Pellet |
|---|---|---|---|
| Sample | Polymer | Force to Fail | Geometry |
| 1 | KRO3 | 1.5 | cylindrical |
| 2 | KK38 | Free Flow | cylindrical |
| 3 | KRO1 | Free Flow | cylindrical |
| 4 | KRO3 no wax | Free Flow | cylindrical |
| 5 | KRO3 no wax | 11 | cylindrical |
| 6 | KK38 | 2 | cylindrical |
| 7 | KRO1 | 2 | cylindrical |
| 8 | KK38 | 7.5 | cylindrical |
| 9 | KRO3 no wax | 9 | cylindrical |
| 10 | KRO1 | Free Flow | cylindrical |
| 11 | KRO3 | Free Flow | cylindrical |
| 12 | KRO3 no wax | Free Flow | cylindrical |
| 13 | KRO3 | Free Flow | cylindrical |
| 14 | KK38 | Free Flow | cylindrical |
| 15 | KRO3 | Free Flow | cylindrical |

KR03 is a commercial styrene-butadiene copolymer that comprises 75% styrene and 25% butadiene, KK38 is a commercial styrene-butadiene copolymer that comprises 70% styrene and 30% butadiene, and KR01 is a commercial styrene-butadiene copolymer that comprises 75% styrene and 25% butadiene (all percentages by weight). “No wax” means that the polymer composition did not comprise any inherent anti-blocking additive i.e., no wax was added during manufacturing of the copolymer. In the other copolymer samples in the table, some wax was generally present as a result of the manufacturing process.

TABLE 2
Commercial Resin Compression Force to Fail Values

| | | lbs of | |
|---|---|---|---|
| Sample | Polymer | Force to Fail | Pellet Geometry |
| 16 | KRO5 | 6 | spherical |
| 17 | KK38 | 11.3 | spherical |
| 18 | KR10 | 18.4 | spherical |
| 19 | KRO1 | 63.5 | spherical |
| 20 | KRO1 | 15.8 | spherical |
| 21 | KRO1 | 16 | spherical |
| 22 | KRO1 | 13.6 | spherical |

KR05 and KR10 are commercial styrene-butadiene copolymers, and both are comprised of approximately 75 % styrene and 25 % butadiene. Table 3 shows the results onal tests on pellets of commercial grade styrene-butadiene copolymers, measured using the 2.5 kg weight.

TABLE 3
Commercial Resin Compression Force to Fail Values

| | | lbs of |
|---|---|---|
| Sample | Polymer | Force to Fail |
| 23 | KK38 | 2 |
| 24 | KRO1 | 2 |
| 25 | XK40 | 7 |
| 26 | KRO3 | Free Flow |
| 27 | KK38 | 7.5 |
| 28 | KRO3 no wax | 9 |
| 29 | KRO1 no wax | 26 |
| 30 | KRO1 no wax | 29 |
| 31 | KRO3 no wax | 37 |

XK40 is a commercial styrene-butadiene copolymer that comprises 76% styrene and 24% butadiene.

Based on the results in Table 3, 40 lbs of force to fail was set as the benchmark for testing antiblocking additives. If a sample failed at 40 lbs or less, then it would be expected to have no problem being removed from different types of storage containers.

A flexible styrene-butadiene copolymer, comprising 64% styrene and 36% butadiene, copolymer was combined with certain additives to determine their effectiveness at preventing agglomeration of pellets. Typical blocking force results for this copolymer without antiblocking additives were greater than 2,000 pounds of force. Typical haze results for the copolymer were around 25.2.

The screening method used, unless otherwise noted, involved adding to the copolymer composition 1.0% by weight loading of the anti-blocking agent and 0.1% mineral oil to help evenly distribute the additive. To determine the effectiveness of the additive, two storage conditions were tested on most additives, which correspond to storage in either a box with a capacity of 1,000 lb of product or a rail car. The box test condition used a 1.25 kg weight and the rail car test condition used a 2.5 kg weight. Both were tested at 150° F. for 90 hours.

Three testing procedures were used to determine the effectiveness of the selected additive: emulsion, dusting and internal compounding. Internal compounding was the preferred technique. Unless otherwise stated, all mixtures used the following mixing procedure: one kilogram of styrene-butadiene copolymer was weighed into a plastic bag. The resin was then placed into a Prodex mixer at 1800 RPM for 60 seconds, to break apart the pellets, and then rebagged. 0.1% by weight of mineral oil was added to the copolymer and shaken to evenly coat the pellets. This was necessary to ensure even distribution of the selected additive through the contents of the bag. A 1.0% by weight loading of the antiblock additive was used as the typical screening amount. The material at this point could be tested as an external dusting agent, tested internally by extruding and pelletizing, or both. If material was extruded, the following conditions applied: 100 RPM extrusion speed, with a temperature profile of 380° F. for the feed zone, 400° F. for the 2^{nd} and 3^{rd} zones and 410° F. on the single hole die. The strand was then placed into a water bath (the strand was wrapped around free rotating strand guides two times to increase residence cooling time in the bath) with circulated water at 48° F. Cold water was very helpful to help keep the strand from sticking to itself. The strand was then fed through an air knife (to remove excess surface water) and then pelletized.

Table 4 summarizes the results of Crodamide SR powder (a stearamide) as an antiblocking agent with the flexible grade styrene-butadiene copolymer (64% styrene, 36% butadiene).

Under the column “Extruded or Dusted,” “extruded” means that the additive was internally mixed inside the extruder. “Dusted” indicates that the additive was dusted on the polymer and added to the cylinders for the 1^{st} stage of the blocking test. The 1.25 kg weight was used to simulate conditions in the 1,000 lb box to determine the effectiveness of Crodamide as an antiblocking agent. As indicated, 1, 2 and 3% levels of Crodamide SR powder were used to determine the reported values. Crodamide SR powder affected the optical properties of injection molder parts in terms of increased haze values. Since the additive performed in this manner, it gave hope that it would provide some protection by itself or in combination with other antiblocking additives. The finished pellets were observed to agglomerate inside the container during pelletizing.

TABLE 4
Antiblocking Compression Force
to Fail Results for Crodamide SR Powder

| | Extruded | | | Lbs of |
|---|---|---|---|---|
| | or | | Weight | Force to |
| Sample | Dusted | Additive | (kg) | Fail |
| 32 | Extruded | 1.0% Crodamide SR Powder | 1.25 | 17 |
| 33 | Extruded | 2.0% Crodamide SR Powder | 1.25 | 102 |
| 34 | Extruded | 1.0% Crodamide SR Powder w/ | 1.25 | 106 |
| | | Flexible K-Resin no wax | | |
| 35 | Extruded | 3.0% Crodamide SR Powder | 1.25 | 114 |
| 36 | Dusted | 1.0% Crodamide SR Powder | 1.25 | 214 |

Table 5 summarizes the results of Chemstat HTSA #22 (an erucamide) as an antiblocking agent for the same flexible grade styrene-butadiene copolymer (64% styrene, 36% butadiene). The 1.25 kg weight was used to simulate conditions in the 1,000 lb box to determine the effectiveness of Chemstat HTSA #22 as an antiblocking agent. Loading levels of 1 to 5% were used. Chemstat #22 behaved similarly to Crodamide SR Powder when processing. Chemstat #22 allowed pellets to compact easily into testing cylinders for blocking results as the material migrated to the surface of the pellet very quickly, possibly due to a lower melting point of the antiblocking additive.

TABLE 5
Antiblocking Compression Force
to Fail Results for Chemstat HTSA #22

| | | | | Lbs of |
|---|---|---|---|---|
| | Extruded | | Weight | Force |
| Sample | or Dusted | Additive | (kg) | to Fail |
| 37 | Extruded | 5.0% Chemstat HTSA | 1.25 | 55 |
| | | 22 w/o Mineral Oil | | |
| 38 | Extruded | 1.0% Chemstat HTSA 22 | 1.25 | 203 |
| | | w/o Mineral Oil or Silicone | | |
| | | Spray | | |
| 39 | Extruded | 1.0% Chemstat HTSA 22 | 1.25 | 270 |
| | | w/o Mineral Oil | | |
| 40 | Extruded | 2.0% Chemstat HTSA 22 | 1.25 | 303 |
| | | w/o Mineral Oil | | |
| 41 | Extruded | 1.0% Chemstat HTSA 22 | 1.25 | 342 |
| | | & 0.1% Mineral Oil | | |
| 42 | Extruded | 1.0% Chemstat HTSA 22 | 2.5 | 333 |
| | | w/0.1% Mineral Oil | | |
| 43 | Extruded | 1.0% Chemstat HTSA 22 | 2.5 | 328 |
| | | w/0.1% Mineral Oil | | |

Table 6 summarizes the results of Kemamide B (a behenamide) as an antiblocking agent for the same flexible grade styrene-butadiene copolymer (64% styrene, 36% butadiene). The 1.25 kg weight was used to simulate conditions in the 1,000 lb box to determine the effectiveness of Kemamide B as an antiblocking agent. Loading levels of 1 to 3% were used to determine the reported values. Kemamide B behaved much like the Chemstat #22 additive when extruding. After sitting at ambient temperatures when bagged, it did not agglomerate like many of the other antiblocking additives.

TABLE 6
Antiblocking Compression Force to Fail Results for
Kemamide B with styrene-butadiene copolymer

| | | | | Lbs of |
|---|---|---|---|---|
| | Extruded | | Weight | Force to |
| Sample | or Dusted | Additive | (kg) | Fail |
| 44 | Extruded | 1.0% Kemamide B and | 1.25 | 72 |
| | | 0.2% Mineral Oil | | |
| 45 | Extruded | 2.0% Kemamide B and | 1.25 | 194 |
| | | 0.1% Mineral Oil | | |
| 46 | Extruded | 3.0% Kemamide B and | 1.25 | 473 |
| | | styrene-butadiene copolymer | | |
| | | no wax | | |
| 47 | Dusted | 1.0% Kemamide B and | 1.25 | 1989 |
| | | 0.2% Mineral Oil | | |

Table 7 summarizes the results when Crodamide SR (a stearamide) and Chemstat HTSA #22 (an erucamide) were tested together as an antiblocking agent blend for the same flexible grade styrene-butadiene copolymer (64% styrene, 36% butadiene). 0.5% to 1.0% of each additive was used as screening levels to determine the effectiveness of this combination. The box and railcar weights were used to simulate respective conditions. The combination of these two additives delivered lower blocking results, on a more consistent basis than any other additives or combinations of additives. Chemstat HTSA #22 (erucamide) has a lower melting point than Crodamide SR (stearamide), thus the erucamide should migrate faster than that of the stearamide. In the melt stage, both the Crodamide and Chemstat should be relatively evenly distributed through the polymer. As the polymer begins to cool, the molecules are expected to migrate to the surface and form a thin lubricating layer. The layer reduces the coefficient of friction (CoF) between surfaces and prevents most unwanted adhesion.

TABLE 7
Antiblocking Results for Combinations of Crodamide SR and Chemstat HTSA #22

| | Extruded | | | Results |
|---|---|---|---|---|
| | Or | | Weight | Lbs |
| Sample | Dusted | Additive | (kg) | of Force |
| 48 | Extruded | 1.0% Crodamide SR and 1.0% Chemstat HTSA 22 (gr) | 1.25 | 24 |
| 49 | Extruded | 1.0% Crodamide SR and 1.0% Chemstat HTSA 22 (gr) | 1.25 | 27 |
| 50 | Extruded | 0.5% Crodamide SR and 0.5% Chemstat HTSA 22 (gr) | 1.25 | 268 |
| 51 | Extruded | 1.0% Crodamide SR and 1% Chemstat HTSA 22, no | 1.25 | 24 |
| | | min oil | | |
| 52 | Extruded | 1.0% Crodamide SR and 1% Chemstat HTSA 22, no | 2.5 | 10 |
| | | min oil | | |
| 53 | Extruded | 1.0% Crodamide SR and 1.0% Chemstat HTSA 22 (gr) | 2.5 | 36 |
| 54 | Extruded | 1.0% Crodamide SR and 1.0% Chemstat HTSA 22 (gr) | 2.5 | 47 |
| 55 | Extruded | 0.5% Crodamide SR and 0.5% Chemstat HTSA 22 (gr) | 2.5 | 80 |
| 56 | Extruded | 1.0% Crodamide SR/1.0% Chemstat HTSA 22 (gr) | 1.25 | 8 |
| 57 | Extruded | 0.5% Crodamide SR/0.5% Chemstat HTSA 22 (gr) | 1.25 | 11 |
| 58 | Extruded | 0.35% Crodamide SR/0.35% Chemstat HTSA 22 (gr) | 1.25 | Free Flow |
| 59 | Extruded | 1.0% Crodamide SR & 1.0% Chemstat HTSA 22 | 1.25 | 11 |
| 60 | Extruded | 1.0% Crodamide SR & 1.0% Chemstat HTSA 22 | 1.25 | 37 |
| 61 | Extruded | 1.0% Crodamide SR & 1.0% Chemstat HTSA 22 | 2.5 | 147 |
| 62 | Extruded | 1.0% Crodamide SR & 1.0% Chemstat HTSA 22 | 1.25 | 44 |
| 63 | Extruded | 1.0% Crodamide SR & 1.0% Chemstat HTSA 22 | 2.5 | 85 |
| 64 | Extruded | 1.0% Crodamide SR & 1.0% Chemstat HTSA 22 | 1.25 | 14 |
| 65 | Extruded | 1.0% Crodamide SR & 1.0% Chemstat HTSA 22 | 2.5 | 32 |
| 66 | Extruded | 1.0% Crodamide SR & 1.0% Chemstat HTSA 22 | 2.5 | 3 |
| 67 | Extruded | 1.0% Crodamide SR & 1.0% Chemstat HTSA 22 | 2.5 | 25 |

“GR ” indicates that the additive was in granular form.

Table 8 summarizes the results of Kemamide B (a behenamide) and Chemstat HTSA #2 (an erucamide) as an antiblocking agent blend for the same flexible grade styrene-butadiene copolymer (64% styrene, 36% butadiene). 0.5% to 1.0% of each additive was used as a screening level to determine the effectiveness of this combination. Both the box and railcar weights were used to simulate respective conditions. The combination of these two additives delivered lower blocking results. Again, Chemstat HTSA #22 (erucamide) has a lower melting point than Kemamide B (behenamide), thus the erucamide should migrate faster than behenamide. In the melt stage, Kemamide B and Chemstat HTSA #22 should be relatively evenly distributed through the polymer. As the polymer begins to cool, the molecules are expected to migrate to the surface and form a thin lubricating layer. The layer reduces the coefficient of friction (CoF) between surfaces and prevents most unwanted adhesion.

TABLE 8
Antiblocking Results for Combinations of Kemamide B and Chemstat HTSA #22

| | | | | Results |
|---|---|---|---|---|
| | Extruded | | Weight | Lbs of |
| Sample | or Dusted | Additive | (kg) | Force |
| 68 | Extruded | 1.0% Kemamide B and 1.0% Chemstat HTSA 22 (no oil) | 1.25 | 11 |
| 69 | Extruded | 1.0% Kemamide B and 1.0% Chemstat HTSA 22 | 1.25 | 40 |
| | | (ground) | | |
| 70 | Extruded | 0.5% Kemamide B and 0.5% Chemstat HTSA 22 | 1.25 | 95 |
| | | (ground) | | |
| 71 | Extruded | 1.0% Kemamide B and 1.0% Chemstat HTSA 22 | 1.25 | Free |
| | | (ground) | | Flow |
| 72 | Extruded | 1.0% Kemamide B and 1.0% Chemstat HTSA 22 | 2.5 | 25 |
| | | (ground) | | |
| 73 | Extruded | 1.0% Kemamide B and 1.0% Chemstat HTSA 22 | 2.5 | 94 |
| | | (ground) | | |
| 74 | Extruded | 1.0% Kemamide B and 1.0% Chemstat HTSA 22 (no oil) | 2.5 | 107 |
| 75 | Extruded | 1.0% Kemamide B and 1.0% Chemstat HTSA 22, | 2.5 | 113 |
| | | w/0.1% Oil | | |
| 76 | Extruded | 0.5% Kemamide B and 0.5% Chemstat HTSA 22 | 2.5 | Free |
| | | (ground) | | Flow |
| 77 | Extruded | 0.5% Kemamide B/0.5% Chemstat HTSA 22 (ground) | 1.25 | 18 |
| 78 | Extruded | 1.0% Kemamide B/1.0% Chemstat HTSA 22 (ground) | 1.25 | 15 |
| 79 | Extruded | 1.0% Kemamide B & 1.0% Chemstat HTSA 22 | 1.25 | 62 |
| 80 | Extruded | 1.0% Kemamide B & 1.0% Chemstat HTSA 22 | 1.25 | 49 |
| 81 | Extruded | 1.0% Kemamide B & 1.0% Chemstat HTSA 22 | 2.5 | 184 |
| 82 | Extruded | 1.0% Kemamide B & 1.0% Chemstat HTSA 22 | 1.25 | 36 |
| 83 | Extruded | 1.0% Kemamide B & 1.0% Chemstat HTSA 22 | 2.5 | 71 |
| 84 | Extruded | 1.0% Kemamide B & 1.0% Chemstat HTSA 22 | 2.5 | 47 |
| 85 | Extruded | 1.0% Kemamide B & 1.0% Chemstat HTSA 22 | 2.5 | 76 |

Table 9 summarizes the results of control tests of various styrene-butadiene copolymers without any antiblocking additives, which were used to develop the baseline pellet blocking data. Most of the controls tested would free flow, while some, like KR03 (no wax), had higher blocking values but were still commercially acceptable.

TABLE 9
Antiblocking Results for Commercial Control Resins

| | | | | Results | |
|---|---|---|---|---|---|
| | Extruded | | Weight | Lbs of | Additive |
| Sample | or Dusted | Additive | (kg) | Force | Type |
| 86 | Extruded | KR03 | 1.25 | 1.5 | Control |
| 87 | Extruded | XK40 | 1.25 | 3.5 | Control |
| 88 | Extruded | KRO1 | 1.25 | 10 | Control |
| 89 | Extruded | KR03 no wax | 1.25 | 11 | Control |
| 90 | Extruded | KK38 | 1.25 | Free Flow | Control |
| 91 | Extruded | KR01 | 1.25 | Free Flow | Control |
| 92 | Extruded | KR03 no wax | 1.25 | Free Flow | Control |
| 93 | Extruded | KRO1 | 1.25 | Free Flow | Control |
| 94 | Extruded | KRO1 | 1.25 | Free Flow | Control |
| 95 | Extruded | KRO1 | 1.25 | Free Flow | Control |
| 96 | Extruded | KRO1 | 1.25 | Free Flow | Control |
| 97 | Extruded | KRO1 | 1.25 | Free Flow | Control |
| 98 | Extruded | KRO1 | 1.25 | Free Flow | Control |
| 99 | Extruded | KRO1 | 1.25 | Free Flow | Control |
| 100 | Extruded | KRO1 | 1.25 | Free Flow | Control |
| 101 | Extruded | KRO1 | 1.25 | Free Flow | Control |
| 102 | Extruded | KRO1 | 1.25 | Free Flow | Control |
| 103 | Extruded | KRO1 | 1.25 | Free Flow | Control |
| 104 | Extruded | KRO1 | 1.25 | Free Flow | Control |
| 105 | Extruded | KRO1 | 1.25 | Free Flow | Control |
| 106 | Extruded | KRO1 | 1.25 | Free Flow | Control |
| 107 | Extruded | KRO1 | 1.25 | Free Flow | Control |
| 108 | Extruded | KRO1 | 1.25 | Free Flow | Control |
| 109 | Extruded | KRO1 | 1.25 | Free Flow | Control |
| 110 | Extruded | KRO1 | 1.25 | Free Flow | Control |
| 111 | Extruded | KRO1 | 1.25 | Free Flow | Control |
| 112 | Extruded | KRO1 | 1.25 | Free Flow | Control |
| 113 | Extruded | KRO1 | 1.25 | Free Flow | Control |
| 114 | Extruded | KRO1 | 2.5 | Free Flow | Control |
| 115 | Extruded | KK38 | 2.5 | 2 | Control |
| 116 | Extruded | KR01 | 2.5 | 2 | Control |
| 117 | Extruded | XK40 | 2.5 | 7 | Control |
| 118 | Extruded | KK38 | 2.5 | 7.5 | Control |
| 119 | Extruded | KR03 no wax | 2.5 | 9 | Control |
| 120 | Extruded | KRO1 | 2.5 | 26 | Control |
| 121 | Extruded | KRO1 | 2.5 | 29 | Control |
| 122 | Extruded | KRO3 no wax | 2.5 | 37 | Control |
| 123 | Extruded | KRO1 | 2.5 | Free Flow | Control |
| 124 | Extruded | KRO3 with wax | 2.5 | Free Flow | Control |
| 125 | Extruded | KR03 no wax | 2.5 | Free Flow | Control |
| 126 | Extruded | KR03 | 2.5 | Free Flow | Control |
| 127 | Extruded | KK38 | 2.5 | Free Flow | Control |
| 128 | Extruded | KRO3 with wax | 2.5 | Free Flow | Control |

“With wax” means that wax was added to the copolymer during its manufacturing.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents are chemically related, and may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition comprising:
(a) at least one monovinylarene-conjugated diene copolymer,
(b) at least one erucamide, and
(c) at least one stearamide or behenamide.

2. The composition of claim 1, wherein the composition comprises from about 0.1 wt % to about 5.0 wt % erucamide, and from about 0.1 wt % to about 5.0 wt % stearamide, behenamide, or a combination of the two.

3. The composition of claim 1, wherein the copolymer comprises from about 60 wt % to about 90 wt % monovinylarene.

4. The composition of claim 1, wherein the monovinylarene-conjugated diene copolymer comprises at least two consecutive monovinylarene-conjugated diene tapered blocks.

5. The composition of claim 1, wherein the composition has compression force to fail of less than about 40 pounds.

6. The composition of claim 1, wherein the monovinylarene-conjugated diene copolymer is prepared by a method comprising polymerizing at least one conjugated diene monomer with at least one monovinylarene monomer;
wherein the conjugated diene monomer comprises at least one of 1,3-butadiene, 2-methyl-1,3-butadiene, 2-ethyl-1,3-butadiene, 2,3-dimethyl-1,3-butadiene, 1,3-pentadiene, isoprene, 3-butyl-1,3-octadiene and mixtures thereof; and
wherein the monovinylarene monomer comprises at least one of styrene, alpha-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene and mixtures thereof.

7. The composition of claim 1, wherein the monovinylarene-conjugated diene block copolymer is a styrene-butadiene copolymer.

8. A method of preparing a polymer composition, comprising:
combining (a) at least one monovinylarene-conjugated diene copolymer, (b) at least one erucamide, and (c) at least one stearamide or behenamide.

9. The method of claim 8, wherein the composition comprises from about 0.1 wt % to about 5.0 wt % erucamide, and from about 0.1 wt % to about 5.0 wt % stearamide, behenamide, or a combination of the two.

10. The method of claim 8, wherein the copolymer comprises from about 60 wt % to about 90 wt % monovinylarene.

11. The method of claim 8, wherein the monovinylarene-conjugated diene copolymer comprises at least two consecutive monovinylarene-conjugated diene tapered blocks.

12. The method of claim 8, wherein the composition has compression force to fail of less than about 40 pounds.

13. The method of claim 8, wherein the monovinylarene-conjugated diene copolymer is prepared by a method comprising polymerizing at least one conjugated diene monomer with at least one monovinylarene monomer; wherein the conjugated diene monomer comprises at least one of 1,3-butadiene, 2-methyl-1,3-butadiene, 2-ethyl-1,3-butadiene, 2,3-dimethyl-1,3-butadiene, 1,3-pentadiene, isoprene, 3-butyl-1,3-octadiene and mixtures thereof; and
wherein the monovinylarene monomer comprises at least one of styrene, alpha-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene and mixtures thereof.

14. The method of claim 8, wherein the monovinylarene-conjugated diene block copolymer is a styrene-butadiene copolymer.

15. An article comprising a polymer composition, wherein the polymer composition comprises (a) at least one monovinylarene-conjugated diene copolymer, (b) at least one erucamide, and (c) at least one stearamide or behenamide.

16. The article of claim 15, wherein the article is medical grade tubing.

17. The article of claim 15, wherein the composition comprises from about 0.1 wt % to about 5.0 wt % erucamide, and from about 0.1 wt % to about 5.0 wt % stearamide, behenamide, or a combination of the two.

18. The article of claim 15, wherein the copolymer comprises from about 60 wt % to about 90 wt % monovinylarene.

19. The article of claim 15, wherein the monovinylarene-conjugated diene copolymer comprises at least two consecutive monovinylarene-conjugated diene tapered blocks.

20. The article of claim 15, wherein the composition has compression force to fail of less than about 40 pounds.

21. The article of claim 15, wherein the monovinylarene-conjugated diene copolymer is prepared by a method comprising polymerizing at least one conjugated diene monomer with at least one monovinylarene monomer;
wherein the conjugated diene monomer comprises at least one of 1,3-butadiene, 2-methyl-1,3-butadiene, 2-ethyl-1,3-butadiene, 2,3-dimethyl-1,3-butadiene, 1,3-pentadiene, isoprene, 3-butyl-1,3-octadiene, and mixtures thereof; and
wherein the monovinylarene monomer comprises at least one of styrene, alpha-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene, and mixtures thereof.

22. The article of claim 15, wherein the monovinylarene-conjugated diene block copolymer is a styrene-butadiene copolymer.
